(19) United States
(12) Patent Application Publication
(10) Pub. No.: US 2005/0255341 A1
(43) Pub. Date: Nov. 17, 2005

(54) Direct borohydride fuel cells with hydrogen peroxide oxidant

(76) Inventors: Ashok Kumar Shukla, Bangalore (IN); Ramanujam Kothandaraman, Tamil Nadu (IN); Nurul Alam Choudhury, Assam (IN)

Correspondence Address: WINSTON & STRAWN LLP, 1700 K STREET, N.W., WASHINGTON, DC, 20006, US

(21) Appl. No.: 10/843,455

(22) Filed: May 12, 2004

(51) Int. Cl. H01M 8/00

(52) U.S. Cl. 429/12; 429/33; 429/40

(57) ABSTRACT

This invention describes a novel DBFC employing hydrogen peroxide as oxidant with a power density of about 350 mW/cm² at the cell voltage of almost 1.2V at 70° C.; the open-circuit voltage of the DBFC being as high as about 2V, the use of liquid reactants in DBFCs not only simplifies the engineering problems at the front end of the fuel cell driving down complexity and hence cost but operating a DBFC with an oxidant such as hydrogen peroxide also extends the operational domain of fuel cells to locations where free convection of air is limited, e.g. under water applications.

### TECHNICAL FIELD

The present invention relates to a direct borohydride fuel cell (DBFC) which uses hydrogen peroxide as oxidant. More particularly, the present invention relates to direct borohydride fuel cell which uses hydrogen peroxide as oxidant in conjunction with aqueous sodium borohydride as hydrogen-carrying liquid fuel, hydrogen-storage alloy as anode and Na+-form of Nation™-117 as membrane electrolyte.

### BACKGROUND OF THE INVENTION

A fuel cell is an electrochemical device that continuously converts chemical energy directly into electrical energy for as long as fuel, such as hydrogen, and oxidant, such as oxygen, are supplied to it. There are six generic fuel cell systems, namely (i) phosphoric acid fuel cells, (ii) alkaline fuel cells, (iii) molten carbonate fuel cells, (iv) solid oxide fuel cells, (v) polymer electrolyte fuel cells, and (vi) direct methanol fuel cells.

Among the aforesaid fuel cell systems, polymer electrolyte fuel cells (PEFCs) are considered as front-runner for portable-power applications. Although PEFCs have advanced substantially in terms of their development, their commercialization is still limited owing to the problems related to carbon monoxide poisoning of anode while using a reformer with the PEFC, and hydrogen storage while using a directly fueled PEFC. Therefore, alternative hydrogen-carrying liquid fuels such as methanol, which has a capacity of 5.6 Ah/g and a hydrogen content of 12.5 wt. %, has attracted the attention of fueling PEFCs directly with methanol. Such fuel cells are referred to as direct methanol fuel cells (DMFCs). But DMFCs have limitations of low open-circuit-voltage, low electrochemical-activity, and methanol crossover.

As an obvious solution to the above mentioned problems associated with DMFCs, other promising hydrogen-carrying liquid fuels such as sodium borohydride, which has a capacity value of 5.67 Ah/g and a hydrogen content of about 11 wt %, have been explored. The U.S. Pat. No. 5,599,640, entitled, “Alkaline fuel cell”, issued to Lee et al. (hereafter “Lee”) was the first report of a fuel cell comprising an aqueous alkaline solution of electrolyte containing a hydrogen-releasing agent selected from the group consisting of NaBH₄, KBH₄, LiAlH₄, KH and NaH, an oxygen electrode as cathode and a hydrogen storage alloy electrode as an anode. This fuel cell, however, did not have any membrane electrolyte to restrict the reactants and products from one electrode to diffuse to the other. Amendola et al. were the first to use an OH⁻-ion conducting anion exchange membrane-based borohydride-air fuel cell with a power density close to 60 mWcm⁻² at 70° C., as described in the article entitled, “A novel high power density borohydride-air fuel cell” published in the Journal of Power Sources 84 (1999) pp 130-133 (hereafter “Amendola”). However, the borohydride-air fuel cell described by Amendola suffers from borohydride crossover as the BH₄⁻-ions can easily permeate through the anion exchange membrane. Besides, it would be mandatory to scrub CO₂ from air inlet of such a fuel cell to avoid its carbonate fouling. Li et al. mitigated BH₄⁻ crossover problem by adopting a fuel cell structure using Nafion membrane as electrolyte to separate the fuel from the cathode and could achieve a power density as high as 160 mWcm⁻² at 70° C. with such a fuel cell as described in the article entitled “A Fuel Cell Development for Using Borohydrides as the Fuel” published in the Journal of The Electrochemical Society, 150 (7) A868-A872 (2003) (hereafter “Li”). But even in the borohydride-air fuel cell proposed by Li, it would be mandatory to scrub CO₂ from air both to avoid carbonate fouling as well as to prevent accumulation of alkali in the catholyte to facilitate oxidant flux at the cathode.

Thus, it is essential to come up with an improved direct borohydride fuel cell which does not require constant scrubbing of CO₂ thereby completely avoiding carbonate fouling. Also, it is required to device direct borohydride fuel cells which can work even in the absence of air such as under-water conditions.

### OBJECTS OF THE PRESENT INVENTION

The main object of the present invention is to provide a direct borohydride fuel cell which uses hydrogen peroxide as oxidant.

Another object of the present invention is to provide a DBFC which does not require constant scrubbing of CO₂.

Yet another object of the present invention is to provide a DBFC which completely avoids carbonate fouling.

Still another object of the present invention is to provide a DBFC which can be used in the absence of air such as under-water conditions.

### BRIEF DESCRIPTION OF THE DRAWINGS

The present invention will be described with reference to the accompanying drawings, wherein:

FIG. 1 is a diagram illustrating the construction of the DBFC of the present invention.

FIG. 2 is the cell polarization data for the DBFC operating at temperatures between 40° C. and 70° C. with optimized solution of aqueous NaBH₄ at anode and 15% w/v H₂O₂ solution having pH of ˜1 at the cathode.

FIG. 3 is the cell polarization data for the DBFC operating at temperatures between 35° C. and 70° C. with optimized solution of aqueous NaBH₄ at anode and 15% w/v H₂O₂ solution having pH of 0.5 at the cathode.

FIG. 4 is the cell polarization data for the DBFC operating at temperatures between 35° C. and 70° C. with optimized solution of aqueous NaBH₄ at anode and 15% w/v H₂O₂ solution having pH of 0 at the cathode.

FIG. 5 provides anode and cathode polarization data for the DBFC operating with optimized aqueous NaBH₄ and 15 w/v H₂O₂ solution at different pH values at temperatures between 35° C. and 70° C.

### DETAILED DESCRIPTION OF THE INVENTION

Accordingly, the present invention provides, a direct borohydride fuel cell (DBFC) using Hydrogen peroxide as a liquid oxidant, said DBFC comprising:
(a) a membrane electrode assembly (MEA) comprising an anode and a cathode separated by a membrane, said MEA being housed inside a fuel cell chamber such that the MEA partitions the fuel cell chamber into a cathode chamber and an anode chamber,
(b) a liquid hydrogen releasing agent being in contact with the anode, and
(c) the hydrogen peroxide having pH value in the range of 0 to 2 being in contact with the cathode and the cell potential in the range of 1.64 V to 3.02 V.

In an embodiment, the membrane is a pretreated polymer membrane electrolyte.

In another embodiment, the pretreated membrane electrolyte is made up of H⁺/Na⁺-form of Nafion™-117 or any H⁺/Na⁺ conducting membrane.

In yet another embodiment the liquid hydrogen releasing agent used is aqueous sodium borohydride (NaBH₄), KBH₄, LiAlH₄, KH or NaH or any other hydrogen releasing agent. In yet another embodiment, the anode is made up of a hydrogen storage alloy and wherein sodium borohydride is oxidized at the anode according to the following reactions,
8NaOH 8Na⁺+8OH⁻
NaBH₄+8OH⁻ NaBO₂+6H₂O+8e⁻(E°ₐ=−1.24 V vs. SHE)

In yet another embodiment, the hydrogen storage alloy is selected from the group consisting of AB₅ Misch metallic alloy, an AB₂ Zirconium (Zr) alloy and an AB₂ Titanium (Ti) alloy or any hydrogen storage material with similar characteristics.

In yet another embodiment, the cathode is made up of a carbon electrode dispersed with a catalyst material and wherein the decomposition of H₂O₂ into O₂ and H₂O and electroreduction of H₂O₂ when pH converges to 0 takes place at the catalyst/electrode interface of the cathode according to the reactions,
4H₂O₂ 4H₂O+2O₂
2O₂+4H₂O+8e⁻ 8OH⁻ (E°_{c}=0.4 V vs. SHE)
4H₂O₂+8H⁺+8e⁻ 8H₂O (E°_{c}=1.78 V vs. SHE)

In yet another embodiment, the cathode catalyst material is made up of 60 wt. % Pt/C with platinum loading of 1 mg cm^{-2.}

In yet another embodiment, the maximum power density attainable is about 136 mWcm⁻² at a cell voltage of about 1V while operating with the hydrogen peroxide solution near zero pH at about 35° C.

In another embodiment of the invention, the maximum power density attainable is about 352 mWcm⁻² at a cell voltage of about 1.2V while operating with the hydrogen peroxide solution near zero pH at about 70° C.

The direct borohydride fuel cell of the present invention has a power density of about 350 mWcm⁻² at the cell voltage of almost 1.2 V at 70° C.; the open-circuit voltage of the DBFC is about 2V.

Working of the DBFC

In the following paragraphs, the working of the DBFC is explained.

In the fuel cell of the present invention, sodium borohydride is oxidized at its anode according to the following reactions.
8NaOH 8Na⁺+8OH⁻ (1)
NaBH₄+8OH⁻ NaBO₂+6H₂O+8e⁻ (E°ₐ=−1.24 V vs. SHE) (2)

At the cathode of the DBFC, hydrogen peroxide is decomposed into oxygen and water at the catalyst/electrode interface according to the reactions,
4H₂O₂ 4H₂O+2O₂ (3)
2O₂+4H₂O+8e⁻ 8OH⁻ (E°_{c}=0.4 V vs. SHE) (4)

Electroreduction of hydrogen peroxide is also highly likely according to the reaction,
4H₂O₂+8Na⁺+8e⁻ 8NaOH (E°_{c}=0.87 V vs. SHE) (5)

As the pH of the H₂O₂ solution in the catholyte converges to 0, electroreduction of H₂O₂ will proceed as follows.
4H₂O₂+8H⁺+8e⁻ 8H₂O (E°_{c}=1.78 V vs. SHE) (6)

The variation in H₂O₂ reduction potential with pH is governed by,
E(H₂O₂)=1.78−0.059 pH (7)

The net cell reaction in such a DBFC is,
NaBH₄+4H₂O₂ NaBO₂+6H₂O (8)

The cell potential for this DBFC will range between 1.64 V and 3.02 V depending on the pH of H₂O₂ solution in the catholyte. The specific energy of such a fuel cell will be as high as 17 kWh/kg. Similar to Li, we have also used a Nafion membrane to separate anode and cathode compartments of the fuel cell while selectively employing an AB₅-group MₘNi_{3.55}Al_{0.3}Mn_{0.4}Cu_{0.75} hydrogen-storage alloy, where Mm stands for Misch metal comprising La-30 wt. %, Ce-50 wt. %, Nd-15 wt. %, Pr-5 wt. %, as the anode material. In the literature, both AB₂ and AB₅-group alloys have been successfully employed as negative electrodes in nickel-metal hydride batteries. Although AB₂-group alloys yield superior energy storage density, the AB₅-group alloys have higher hydrogen retention capacity.

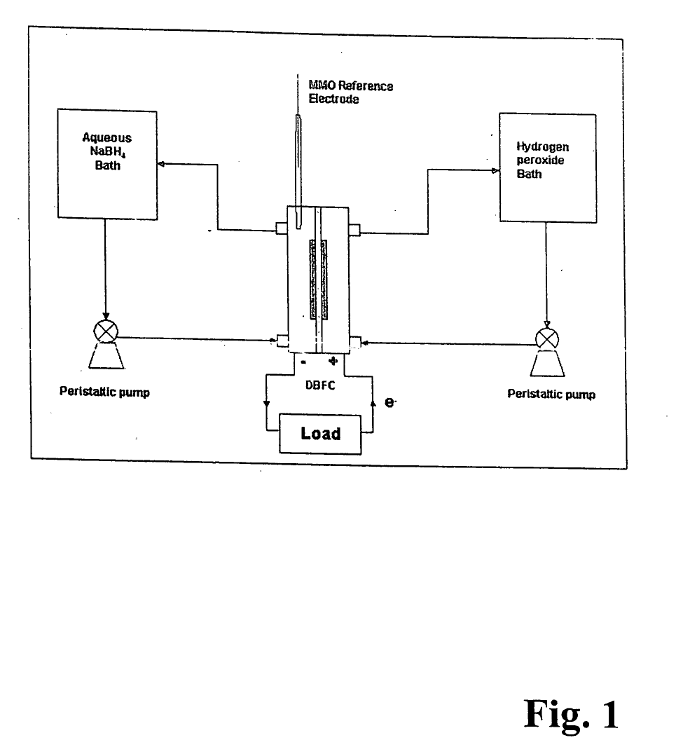

The fuel cell of the present invention will be further illustrated below with reference to FIG. 1 by way of the following examples. The examples are presented for illustrative purposes only, and should not be construed as limiting the invention, which is properly delineated by the claims.

### EXAMPLE 1

The membrane electrode assemblies (MEAs) form a seminal component of various DBFCs of this invention and were obtained by sandwiching the pre-treated Nafion®-117 polymer electrolyte membrane between the anode and cathode. To prepare the anode catalyst layer, a slurry of the alloy obtained by ultra-sonicating the required amount of alloy with 5 wt. % Vulcan XC-72R carbon and 7 wt. % of Nafion® solution in isopropyl alcohol was pasted on carbon paper (Toray TGP-H-090) of 0.28 mm thickness. The loading of alloy catalyst was 5 mgcm⁻², which was kept identical for all the MEAs. The cathode comprises a backing layer, a gas-diffusion layer, and a reaction layer. A carbon paper (Toray TGP-H-090) of 0.28 mm thickness was employed as the backing layer for the cathode. To prepare the gas-diffusion layer, Vulcan-XC 72R carbon was suspended in water and agitated in an ultrasonic water bath. To this, 10 wt. % Nafion solution obtained from Aldrich was added with continuous agitation. The required amount of cyclohexane was then added to it drop wise. The resultant slurry was spread onto a teflonized carbon paper and dried in an air oven at 80° C. for 2 h. To prepare the reaction layer, required amount of the catalyst (60 wt. % Pt/C) was suspended in isopropyl alcohol. The mixture was agitated in an ultrasonic water bath, and 7 wt. % of Nafion® solution was added to it with continuing agitation for 1 h. The catalyst ink thus obtained was coated onto the gas-diffusion layer of the electrode. The cathode contained 60 wt. % Pt/C catalyst with platinum loading of 1 mgcm⁻². A Nafion loading of 0.25 mg cm⁻² was applied to the surface of each electrode. The membrane electrode assembly was obtained by hot pressing the cathode and anode on either side of a pre-treated Nafion®-117 membrane at 60 kg cm⁻² at 125° C. for 3 min.

Liquid-feed DBFCs were assembled with various MEAs. The anode and cathode of the MEA were contacted on their rear with gas/fluid flow field plates machined from high-density graphite blocks in which channels were machined to achieve minimum.

Mass-polarization in the DBFCs. The ridges between the channels make electrical contact with the back of the electrode and conduct the current to the external circuit. The channels supply alkaline sodium borohydride solution to the anode and hydrogen peroxide to the cathode. Electrical heaters were placed behind each of the graphite blocks to heat the cell to the desired temperature. Aqueous sodium borohydride solution comprising 10 wt. % NaBH₄ in 20 wt. % aqueous NaOH was pumped to the anode chamber through a peristaltic pump. Hydrogen peroxide 15% w/v solution with varying pH was introduced into the cathode chamber through another peristaltic pump. The graphite blocks were also provided with electrical contacts and tiny holes to accommodate thermocouples. After installing single cells in the test station, performance evaluation studies were initiated.

Galvanostatic-polarization data for the DBFC in the temperature range between 35° C. and 70° C. were recorded by circulating aqueous sodium borohydride solution in the anode chamber and 15% w/v hydrogen peroxide solution adjusted to various pH values ranging between 1 and 0 in the cathode chamber. Anode polarization data for the DBFC at various temperatures were also obtained employing an Hg/HgO, OH⁻ (MMO) reference electrode. Cathode polarization data were derived by subtracting anode polarization values from the respective cell polarization data at various load current-densities.

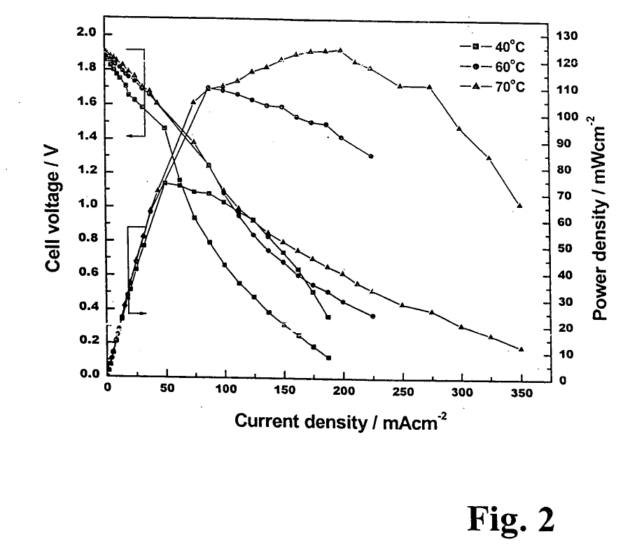

The anode was fed with aqueous NaBH₄ solution at a feed rate of 3 ml/min, and the cathode was fed with 15% w/v H₂O₂ solution with pH values close to 1 at a feed rate of 5.5 ml/min to the cathode. The cell performance data at various temperatures are shown in FIG. 2. While various embodiments of the present invention have been described above, it should be understood that they have been presented by way of example only, and not to imply any limitation. Thus, the breadth and scope of the present invention should not be limited by any of the exemplary embodiments described above, but should be defined only in accordance with the following claims and their equivalents.

### EXAMPLE 2

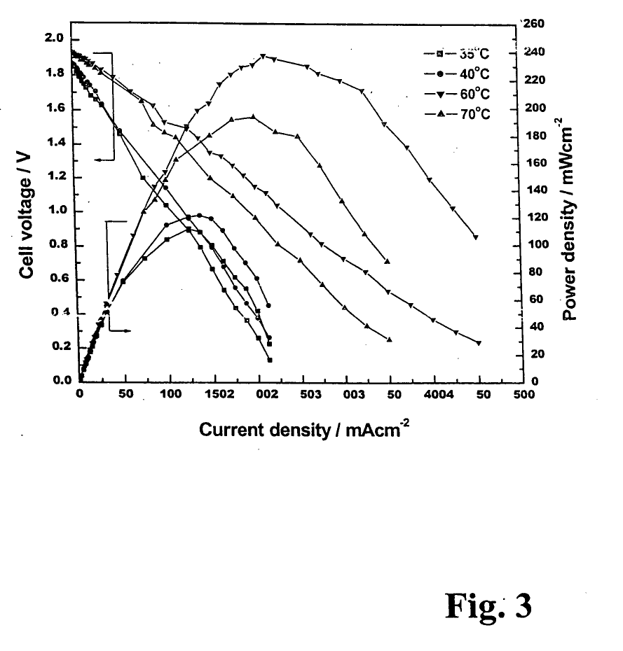

A DBFC operating with the anode with aqueous NaBH₄, solution at a feed rate of 3 ml/min, and the cathode with 15% w/v H₂O₂ solution with pH values close to 0.5 at a feed rate of 5.5 ml/min to the cathode was also studied in addition to Example 1. The cell performance data at various temperatures are shown in FIG. 3.

### EXAMPLE 3

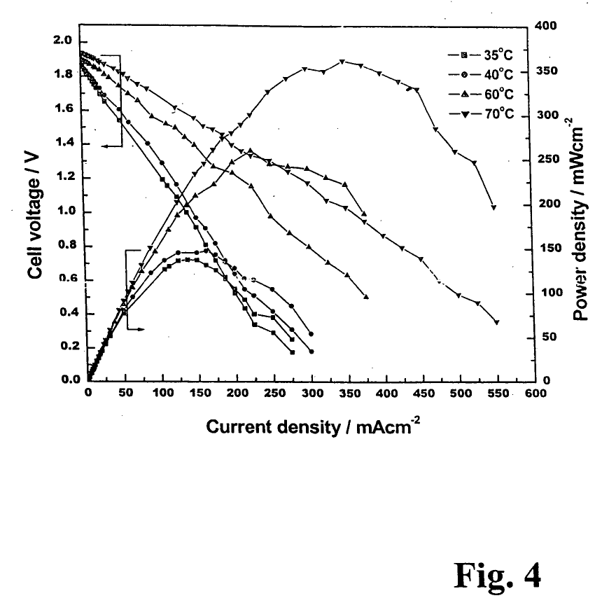

A DBFC operating with the anode with aqueous NaBH₄ solution at a feed rate of 3 ml/min, and the cathode with 15% w/v H₂O₂ solution with pH values close to 0 at a feed rate of 5.5 ml/min to the cathode was also studied in addition to Examples 1 and 2. The cell performance data at various temperatures are shown in FIG. 4.

Table 1 below summarizes the electrical performance data of the DBFCs presented as Example 1, 2 and 3 above.

| | Peak power density (mWcm⁻²) at | | | | Cell voltage (V) at peak power | | | |
|---|---|---|---|---|---|---|---|---|
| Catholyte | different temperatures | | | | density at different temperatures | | | |
| PH | 35° C. | 40° C. | 60° C. | 70° C. | 35° C. | 40° C. | 60° C. | 70° C. |
| ˜1 | — | 70 | 110 | 130 | — | 1.5 | 1.2 | 0.7 |
| ˜0.5 | 112 | 122 | 194 | 236 | 0.90 | 0.89 | 0.98 | 1.1 |
| ˜0 | 136 | 146 | 260 | 352 | 1.0 | 0.98 | 1.2 | 1.2 |

It has been possible to attain a maximum power density of 136 and 352 mWcm⁻² at a cell voltage of 1 V and 1.2 V while operating such a DBFC employing hydrogen peroxide solution as oxidant with near zero pH at 35° C. and 70° C., respectively. The operational conditions for the DBFCs, however, are not yet fully optimized, and a further enhancement in its performance is highly likely. In order to obtain a large-sized cell, several unit cells could be connected in series as is conventionally done to form a fuel cell stack.

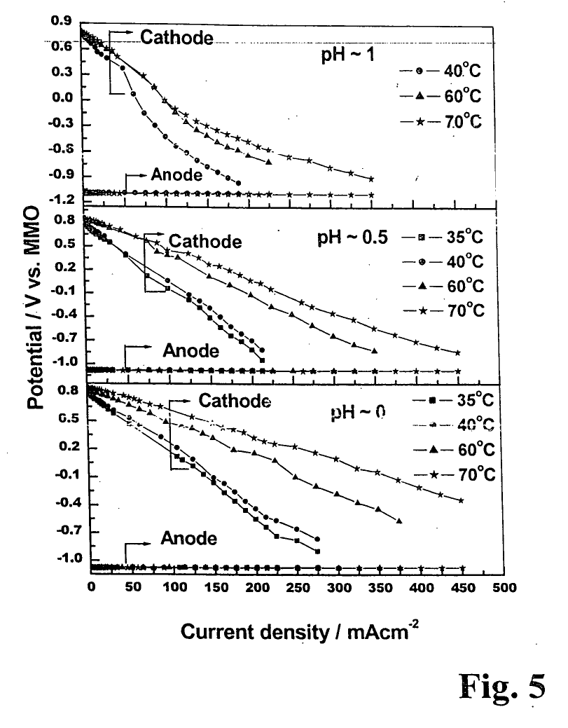

Single-electrode polarization curves at various operational temperatures for the catholyte with varying pH values are shown in FIG. 5. While the anode potentials are close to its thermodynamic value, the cathode shows substantial polarization losses rendering the DBFC cathode limited. Accordingly, in future, as it becomes possible to realize an effective cathode catalyst for H₂O₂ reduction, it would be feasible to produce DBFCs with voltages near 3 V, which is close to the voltages achieved with any of the advanced lithium cells. We believe that such a fuel cell with its high output voltage would provide a pragmatic gateway to solve the most challenging problem associated with the currently available batteries, namely their limited energy density.

Advantages of the Present Invention

1. The direct borohydride fuel cell uses a liquid oxidant H₂O₂ and does not require any free convection of air and can be used for under water applications.
2. The cell potential is in the range of 1.64V to 3.02 V.
3. The maximum power density attainable is about 136 mWcm⁻² and 352 mWcm-2 at cell potentials of about 1V and 1.2 V while operating with the hydrogen peroxide solution near zero pH at about 35° C. and 70° C. respectively.

1. A direct borohydride fuel cell (DBFC) using Hydrogen peroxide as a liquid oxidant, said DBFC comprising:
(a) a membrane electrode assembly (MEA) comprising an anode and a cathode separated by a membrane, said MEA being housed inside a fuel cell chamber such that the MEA partitions the fuel cell chamber into a cathode chamber and an anode chamber,
(b) a liquid hydrogen releasing agent being in contact with the anode, and
(c) the hydrogen peroxide having pH value in the range of 0 to 2 being in contact with the cathode the cell potential in the range of 1.64 V to 3.02 V.

2. The direct borohydride fuel cell as claimed in claim 1, wherein the membrane is a pretreated polymer membrane electrolyte.

3. The direct borohydride fuel cell as claimed in claim 2, wherein the pretreated membrane electrolyte is made up of H⁺ or Na⁺-form of conducting membrane.

4. The direct borohydride fuel cell as claimed in claim 3, wherein the conducting membrane is H⁺/Na⁺ form of Nafion™-117.

5. The direct borohydride fuel cell as claimed in claim 1, wherein the liquid hydrogen releasing agent used is aqueous sodium borohydride NaBH₄, KBH₄, LiAlH₄, KH or NaH or any other hydrogen releasing agent.

6. The direct borohydride fuel cell as claimed in claim 1, wherein the anode is made up of a hydrogen storage alloy and wherein sodium borohydride is oxidized at the anode according to the following reactions:
8NaOH 8Na⁺+8OH⁻
NaBH₄+8OH⁻ NaBO₂+6H₂O+8e⁻ (E°ₐ=−1.24 V vs. SHE)

7. The direct borohydride fuel cell as claimed in claim 6, wherein the hydrogen storage alloy is selected from the group consisting of AB₅ Misch metallic alloy, an AB₂ Zirconium (Zr) alloy and an AB₂ Titanium (Ti) alloy, or any hydrogen storage material with similar characteristics.

8. The direct borohydride fuel cell as claimed in claim 1, wherein the cathode is made up of a carbon electrode dispersed with a catalyst material and wherein the decomposition of H₂O₂ into O₂ and H₂O and electroreduction of H₂O₂ when pH converges to 0 takes place at the catalyst/electrode interface of the cathode according to the reactions,
4H₂O₂ 4H₂O+2O₂
2O₂+4H₂O+8e⁻ 8OH⁻ (E°_{c}=0.4 V vs. SHE)
4H₂O₂+8H⁺+8e⁻ 8H₂O (E°_{c}=1.78 V vs. SHE)

9. The direct borohydride fuel cell as claimed in claim 7, wherein the cathode catalyst material is made up of 60 wt. % Pt/C with platinum loading of 1 mg cm⁻².

10. The direct borohydride fuel cell as claimed in claim 1, wherein the maximum power density attainable is about 136 mWcm⁻² at a cell voltage of about 1V while operating with the hydrogen peroxide solution near zero pH at about 35° C.

11. The direct borohydride fuel cell as claimed in claim 1, wherein the maximum power density attainable is about 352 mWcm⁻² at a cell voltage of about 1.2V while operating with the hydrogen peroxide solution near zero pH at about 70° C.
